(19) United States
(12) Patent Application Publication
(10) Pub. No.: US 2013/0179824 A1
(43) Pub. Date: Jul. 11, 2013

(54) Tag-Based User Interface Management

(71) Applicants: Luca Lazzaro, Naples (IT); Gianluca Perreca, Rome (IT); Alessandro Scotti, Rome (IT); Federico Spiti, Rome (IT)

(72) Inventors: Luca Lazzaro, Naples (IT); Gianluca Perreca, Rome (IT); Alessandro Scotti, Rome (IT); Federico Spiti, Rome (IT)

(73) Assignee: INTERNATIONAL BUSINESS MACHINES CORPORATION, Armonk, NY (US)

(21) Appl. No.: 13/344,748

(22) Filed: Jan. 6, 2012

(51) Int. Cl. G06F 3/048

(52) U.S. Cl. 715/777; 715/780

(57) ABSTRACT

A method, computer program product, and apparatus for managing a user interface. In one illustrative embodiment, a number of tags associated with a group of fields is identified for display in the user interface responsive to receiving a request to display the user interface. A number of policies for displaying fields in the user interface comprising a priority for a tag in the number of tags is identified. The fields are displayed according to the priority for the tag in the number of tags identified in the number of policies.

### BACKGROUND

1. Field

The disclosure relates generally to an improved data processing system and more specifically to a user interface in an improved data processing system. More specifically, the disclosure relates to a method, computer program product, and apparatus for managing a user interface.

2. Description of the Related Art

User interfaces are commonly used in data processing systems to present information to users. The user interface displays the information such that the user may receive and interpret the desired information. In some illustrative examples, the user interface is graphical. In other words, the user interface presents information using graphics and/or text. For example, the data processing system may display the graphical user interface to present requested information from a sales database.

The user interface may also request information from the user. For example, the data processing system may generate a user interface that requests sales data to be stored in a sales database or customer information to be stored in a customer database. In one illustrative example, the user interface includes one or more fields. A field is an area of the user interface where information may be displayed and/or entered. The field may have a title. For example, a field may display the name of a customer and display a title for the field of “Customer Name.”

A user interface may be designed by a human designer. The human designer decides where and how each component of the user interface should be displayed. The human designer may arrange the components of the user interface by logical order, cultural expectations, or another suitable technique. The layout of the user interface may differ depending on the culture of the designer and/or the culture of the users that will use the user interface.

For example, in the United States, the designer may designate a field requesting the surname of a person to be located after a field requesting the given name of the person. In another culture, however, the designer may designate the surname field to be located before the given name field. In another illustrative example, a designer may locate a postal code field close to an address field, while a designer in another culture may locate the postal code field close to a state field.

User interfaces may also be configured to present certain information on a first screen and other information on a second screen. The user may cause the data processing system to switch between screens by using a component of the user interface, such as clicking a tab in a list of tabs. The designer may designate a particular screen for information based on the culture of the designer and/or users of the interface, an organization that appears logical to the designer, or another suitable reason.

### SUMMARY

The different illustrative embodiments provide a method, computer program product, and apparatus for managing a user interface. In one illustrative embodiment, a number of tags associated with a group of fields is identified for display in the user interface responsive to receiving a request to display the user interface. A number of policies for displaying fields in the user interface comprising a priority for a tag in the number of tags is identified. The fields are displayed according to the priority for the tag in the number of tags identified in the number of policies.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a diagram of a data processing system in accordance with an illustrative embodiment;

FIG. 3 is an illustration of a block diagram of a user interface management environment in accordance with an illustrative embodiment;

FIG. 4 is an illustration of a user interface presented in tabular form in accordance with an illustrative embodiment;

FIG. 5 is an illustration of the tags associated with each field in the user interface in accordance with an illustrative embodiment;

FIG. 6 is an illustration of a user interface in tabular form in accordance with an illustrative embodiment;

FIG. 7 is an illustration of a user interface in graphical form in accordance with an illustrative embodiment;

FIG. 8 is an illustration of a flowchart of a process for managing a user interface in accordance with an illustrative embodiment; and

FIG. 9 is an illustration of a flowchart of a process for generating a user interface in accordance with an illustrative embodiment.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment, (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

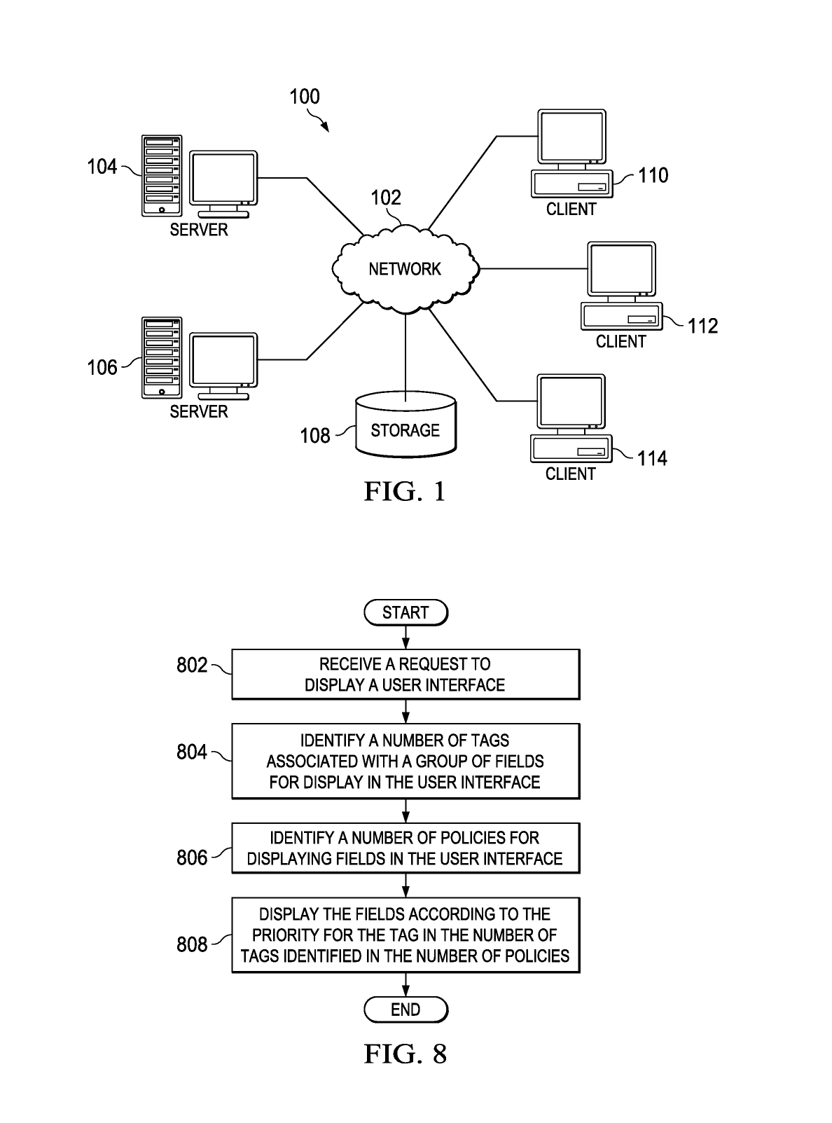

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Server computer 104 and/or server computer 106 store image files or have access to image files stored in storage unit 108 in these illustrative examples. Client computers 110, 112, and 114 may request image files from server computer 104 and/or server computer 106. Such image files may be made accessible on a website using a web server process running on server computer 104 and/or server computer 106. Alternatively, server computer 104 and/or server computer 106 may make the image files accessible to client computers 110, 112, and 114 using a social network server process.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example and not as an architectural limitation for the different illustrative embodiments.

In these illustrative examples, client computer 110 generates a request to generate a user interface and sends the request to server computer 104 using network 102. The user interface may request information from a user and/or display information to a user. Server computer 104 receives the request and identifies fields that are to be displayed in the user interface. Server computer 104 also identifies tags that are associated with each field in the user interface. While the user interface in this illustrative example includes fields, the user interface may also include other components in other illustrative embodiments. For example, the user interface may include graphics and other presentations of information and/or requests for information.

Server computer 104 also identifies a number of policies for displaying the user interface. The policies may include a priority for particular tags in displaying the user interface. For example, a policy generated by an enterprise may include a tag named “company required.” The policy may indicate that the “company required” tag is to have the highest priority among tags associated with a particular field.

Server computer 104 then adds the fields to the user interface at locations in the user interface that are associated with tags having the highest priority for tags associated with a particular field. For example, server computer 104 may generate the fields on tabs that have the same highest priority tag. Server computer 104 then sends the user interface to client computer 110 for display using client computer 110. In another illustrative embodiment, server computer 104 causes client computer 110 to display the user interface.

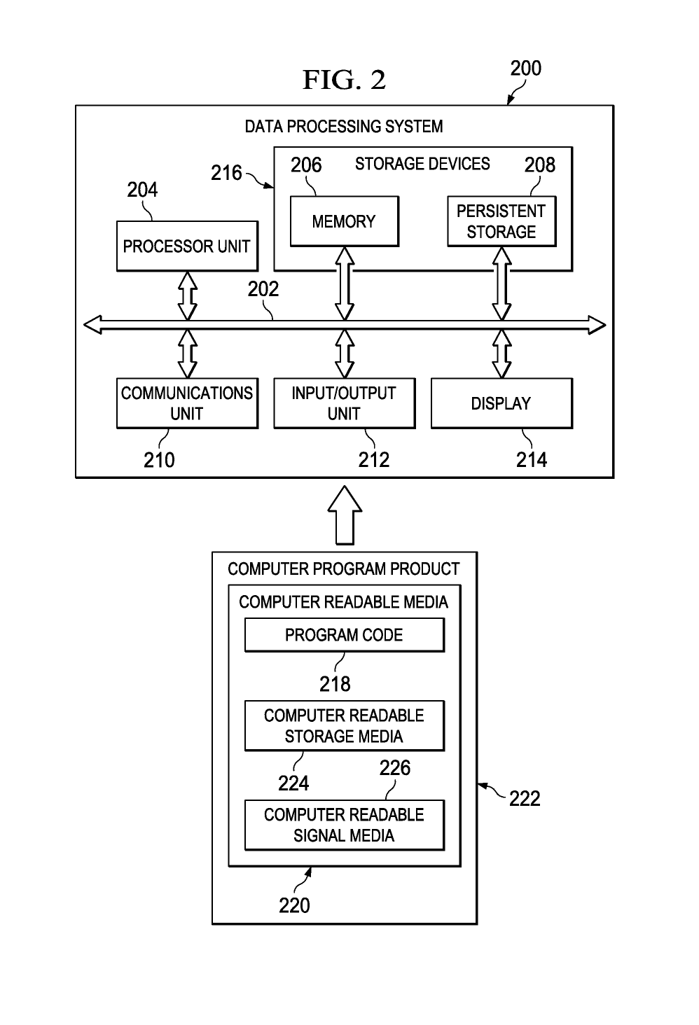

Turning now to FIG. 2, a diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214. Data processing system 200 is an example of a data processing system that can be used to implement server computers and client computers in network data processing system 100 in FIG. 1.

Processor unit 204 serves to process instructions for software that may be loaded into memory 206. Processor unit 204 may be a number of processors, may be a multi-processor core, or some other type of processor, depending on the particular implementation. A “number,” as used herein, with reference to an item, means “one or more items.” Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and processed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200. In these illustrative examples, computer readable storage media 224 is a non-transitory computer readable storage media.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to and/or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components, and/or may be comprised entirely of organic components, excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form. In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

The different illustrative embodiments recognize and take into account a number of different considerations. For example, the different illustrative embodiments recognize and take into account that a particular user interface may be easier and/or faster to use for one user than another user. In one illustrative example, a first user uses particular fields in a user interface more frequently than another user uses the same fields.

The different illustrative embodiments recognize and take into account that displaying components of a user interface such that frequently used and/or desired components are located in an area of the interface desired by the user allows a user to easily locate and navigate through the components. For example, a user entering customer information into a user interface may desire to locate name and address fields first on a first tab of the user interface. Less frequently used fields, such as a notes field about a customer, may be desired by a user to be located after name and phone number fields for the customer in the interface. In another illustrative example, the user may desire the notes field to be located on another tab of the user interface.

The different illustrative embodiments recognize and take into account that a user who frequently uses a particular interface may be aware of the fields frequently used by the user and/or a desired ordering or layout that is most effective for the particular user. Thus, the different illustrative embodiments allow a user to customize the layout of the user interface by associating tags generated by the user with the components in the user interface. The different illustrative embodiments then use a number of policies and the user-generated tags to position the components of the user interface.

The different illustrative embodiments also recognize and take into account that the number of policies and/or the tags may be generated by different entities. In other words, generating the number of policies and/or the number of tags may be a collaborative process that includes multiple individuals and/or entities. For example, an enterprise may generate a first number of tags for the components of the user interface. A user in the enterprise may generate a second number of tags for the components of the user interface. The different illustrative embodiments generate a policy for the enterprise and a policy for the user using the first number of tags and the second number of tags, respectively. When the user interface is generated, the different illustrative embodiments generate the user interface according to the policies and the tags. For example, the enterprise policy may indicate that fields that are tagged with the name required are to appear on a first tab of the user interface. The user policy may further indicate that the fields containing the name of the user are to appear on the first tab.

The different illustrative embodiments provide a method, computer program product, and apparatus for managing a user interface. In one illustrative embodiment, a number of tags associated with a group of fields is identified for display in the user interface responsive to receiving a request to display the user interface. A number of policies for displaying fields in the user interface comprising a priority for a tag in the number of tags is identified. The fields are displayed according to the priority for the tag in the number of tags identified in the number of policies.

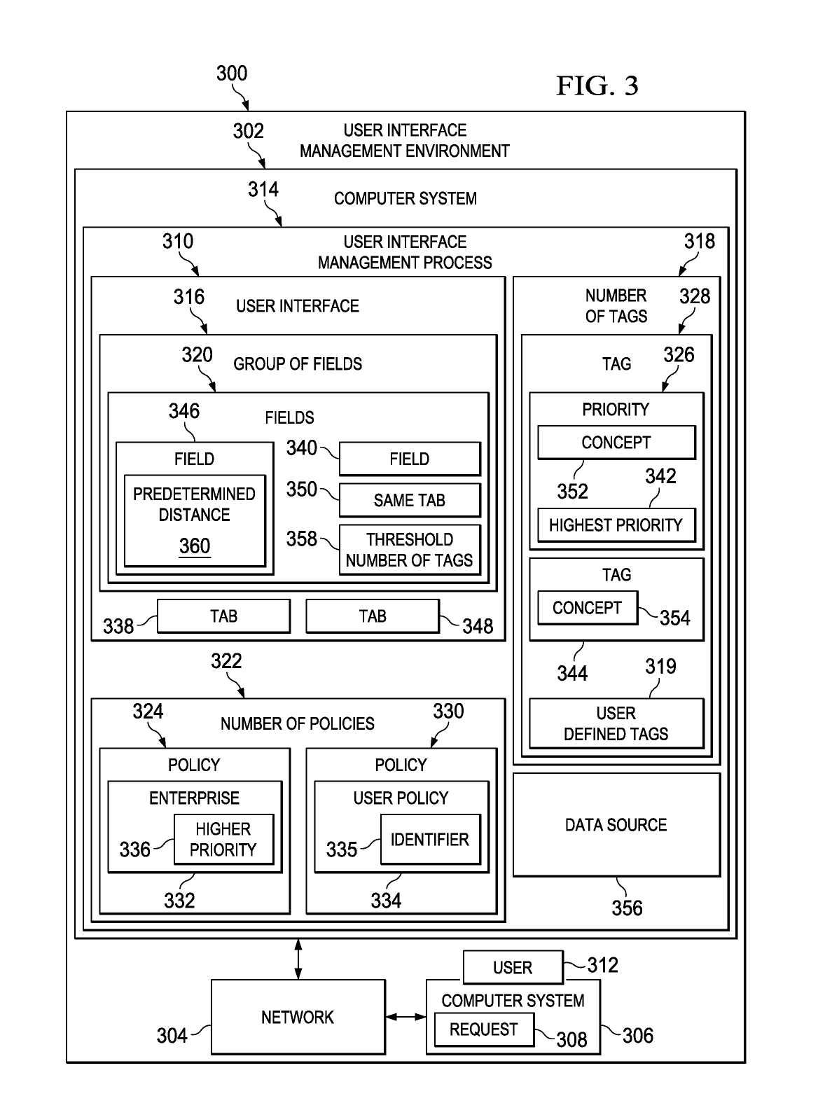

Turning now to FIG. 3, an illustration of a block diagram of a user interface management environment is depicted in accordance with an illustrative embodiment. User interface management environment 300 is an example of an environment in which illustrative embodiments may be implemented.

In these illustrative embodiments, user interface management environment 300 includes computer system 302, network 304, and computer system 306. Computer system 302 is a set of computers including one or more computers in these illustrative embodiments. Likewise, computer system 306 is a set of computers including one or more computer systems. Computer system 302 and computer system 306 are example implementations of data processing system 200 in FIG. 2. Computer system 306 generates request 308. Request 308 is a request to generate user interface 310 on computer system 302. User interface 310 is a graphical user interface in these illustrative examples. For example, in one illustrative embodiment, user interface 310 is displayed using one or more graphical items. More specifically, text, drawings, graphics, and/or other suitable elements may be in user interface 310. In this illustrative example, user 312 causes computer system 306 to generate request 308. For example, user 312 may activate a user interface component being displayed by computer system 306 to generate request 308. In another illustrative example, user 312 activates a component of a user interface generated by computer system 302 and received by computer system 306 across network 304.

Computer system 306 sends request 308 across network 304, and request 308 is received by computer system 302. Computer system 302 runs user interface management process 314. In this illustrative example, computer system 302 runs user interface management process 314 by processing instructions stored in a memory. Computer system 302 receives request 308 such that the contents of request 308 are received by user interface management process 314. For example, user interface management process 314 may cause computer system 302 to listen for request 308 to be received across network 304. User interface management process 314 may also instruct computer system 302 to send request 308 or a portion of request 308 to user interface management process 314 as the message.

Once user interface management process 314 receives request 308, user interface management process 314 generates user interface 310. User interface 310 is one or more screens that display information to a user and/or request information from a user. For example, user interface 310 may display information about a customer and request information from the user about sales to the customer. Of course, in other illustrative embodiments, user interface 310 may include components that are not visual. For example, user interface 310 may include audio components, such as playing and/or recording audio.

In these illustrative examples, the user interface 310 includes group of fields 316. Group of fields 316 is a collection of areas of the user interface where information may be displayed and/or entered. The collection of areas includes one or more areas in this illustrative embodiment. Thus, group of fields 316 includes one or more areas of the user interface where information may be displayed and/or entered. Each field in group of fields 316 may have a title and/or a data portion. For example, a field may display the name of a customer and display a title for the field of “Customer Name.”

A field in group of fields 316 may be associated with number of tags 318. Number of tags 318 is a collection of data that is associated with the field and describes the contents of the field. For example, a field that contains the last name of the person may have the tags “last name,” “surname,” “required,” and/or another suitable tag. For example, a tag associated with a field may be tag 328. In some illustrative embodiments, user interface management process 314 receives number of tags 318 to associate with fields 320 prior to receiving request 308. In such an illustrative embodiment, user interface management process 314 associates number of tags 318 with fields 320. Thus, number of tags 318 may be user defined tags 319.

User interface management process 314 also accesses number of policies 322. Number of policies 322 is a collection of rules for displaying fields 320 in user interface 310. In these illustrative examples, a policy may include a priority for particular tags that are associated with fields to be displayed in user interface 310. For example, policy 324 in number of policies 322 includes priority 326 for tag 328 in number of tags 318. In this illustrative embodiment, number of policies 322 includes policy 324 and policy 330.

Policy 324 is generated by enterprise 332, and policy 330 is user policy 334. User policy 334 is a policy generated by a user, such as user 312 using computer system 306. Enterprise 332 is an entity to which user 312 belongs. For example, enterprise 332 may be an employer of user 312. In such an illustrative example, policy 324 generated by enterprise 332 has higher priority 336 than policy 330. A first policy having higher priority 336 than a second policy means that the rules of the first policy will be applied prior to applying the rules of the second policy. In the event that rules in the second policy conflict with rules in the first policy, the conflicting rules in the first policy will be applied. In one illustrative embodiment, user policy 334 indicates a highest priority for tags having identifier 335. Identifier 335 may be the phrase “user required” in some illustrative embodiments.

User interface management process 314 then continues generating user interface 310 by identifying locations in user interface 310 for fields 320. In these illustrative examples, user interface 310 includes tabs. A tab is a component in user interface 310 that demonstrates to the user that multiple screens of information are included in user interface 310. For example, a tab bar is displayed with each tab having a title and the tabs are aligned in a row within the tab bar. The tab bar may include graphics for each tab that resemble an index tab for a collection of documents in the real world.

Thus, user interface management process 314 identifies number of tags 318 associated with field 340 in group of fields 316 and priority 326 for each tag in number of tags 318 according to number of policies 322. User interface management process 314 then designates field 340 associated with tag 328 having highest priority 342 of number of tags 318 associated with field 340 as being displayed on a tab having the name of tag 328.

For example, assume that field 340 is a last name field and tag 328 and tag 344 in number of tags 318 are associated with field 340. In this illustrative example, assume tag 328 is “name information,” while tag 344 is “company required.” Policy 324 for enterprise 332 in which user 312 is working indicates that the tag “company required” has a higher priority than all other tags, including “last name.” Thus, user interface management process 314 generates tab 338 with title “company required” and displays field 340 on tab 338. Another field in group of fields 316, such as field 346, may be associated with the tag “name information” but not “company required.” In such an illustrative example, user interface management process 314 generates tab 348 for field 346. In one illustrative example, the title of tab 348 is “name information.” Of course, in other illustrative embodiments, tab 338 and/or tab 348 may have a different naming scheme. In the event that field 340 and field 346 have the same tag as highest priority 342, user interface management process 314 may display field 340 and field 346 on same tab 350.

In some illustrative embodiments, user interface management process 314 may display field 340 and field 346 on same tab 350 even when field 340 and field 346 have a different tag as highest priority 342 for the respective field. For example, assume field 340 has highest priority 342 tag 328 of “company required” and field 346 has highest priority 342 tag 344 of “user required.”

Field 340 and field 346 may be displayed on different tabs in user interface 310. However, in some illustrative embodiments, tag 328 for field 340 represents concept 352 and tag 344 for field 346 represents concept 354. Concept 352 and concept 354 are the ideas and/or categories of information represented by tag 328 and tag 344, respectively. For example, concept 352 may be “name information” and concept 354 may be “address information.” User interface management process 314 may process tag 328 and tag 344 using a folksonomy. A folksonomy is data that indicates the concepts represented by a word, such as tag 328 and tag 344 in this illustrative embodiment. In this illustrative embodiment, data source 356 includes a folksonomy with which user interface management process 314 processes number of tags 318.

The folksonomy in data source 356 also indicates relatedness between concepts in the folksonomy. For example, the folksonomy would indicate that “red” and “color” are related, while “red” and “parallelogram” are not related. In some illustrative embodiments, user interface management process 314 displays field 340 and field 346 on same tab 350 when tag 328 for field 340 and tag 344 for field 346 are related in data source 356, regardless of whether field 340 and field 346 have the same tag as highest priority 342.

In other illustrative embodiments, user interface management process 314 displays field 340 and field 346 on same tab 350 when field 340 and field 346 have at least threshold number of tags 358 in common. In other words, user interface management process 314 may display field 340 and field 346 on same tab 350 when field 340 and field 346 have different tags as highest priority 342 but have at least threshold number of tags 358 in common between field 340 and field 346. In some illustrative embodiments, user interface management process 314 further displays field 346 within predetermined distance 360 of field 340 when field 340 and field 346 have at least threshold number of tags 358 in common.

User interface management process 314 then sends user interface 310 to computer system 306 for display using network 304. Computer system 306 displays user interface 310. In one illustrative embodiment, user 312 enters additional information into user interface 310, which may be stored on computer system 306 or sent to computer system 302 or another suitable computer system.

The illustration of user interface management environment 300 is not meant to imply physical or architectural limitations to the manner in which different features may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, computer system 302 may send user interface 310 to computer system 306 in the form of messages and/or instructions. For example, computer system 302 may send user interface 310 as Extensible Markup Language. In another illustrative example, computer system 302 sends user interface 310 to computer system 306 as graphics that are displayed using computer system 306. In another illustrative embodiment, data source 356 is stored in another computer system. In such an illustrative embodiment, user interface management process 314 may generate a number of requests to send to another computer system that processes the terms in the requests to identify the concepts represented by the terms and whether the concepts are related in data source 356.

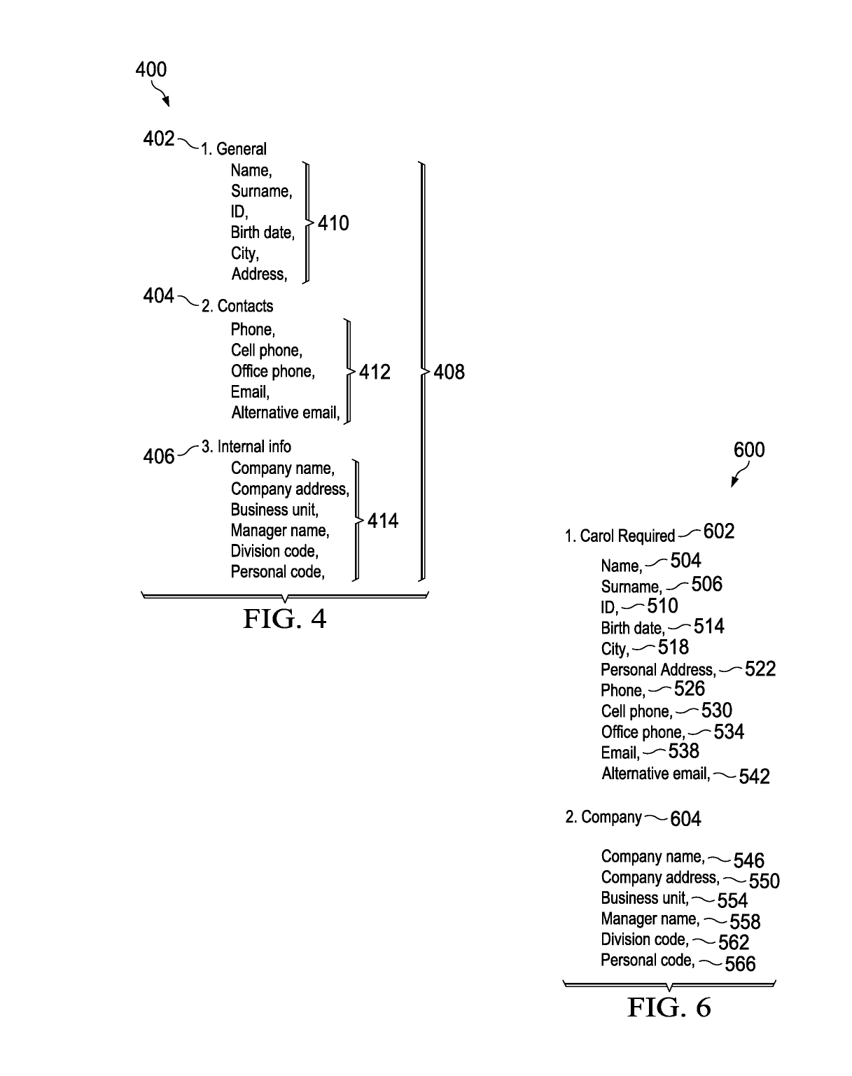

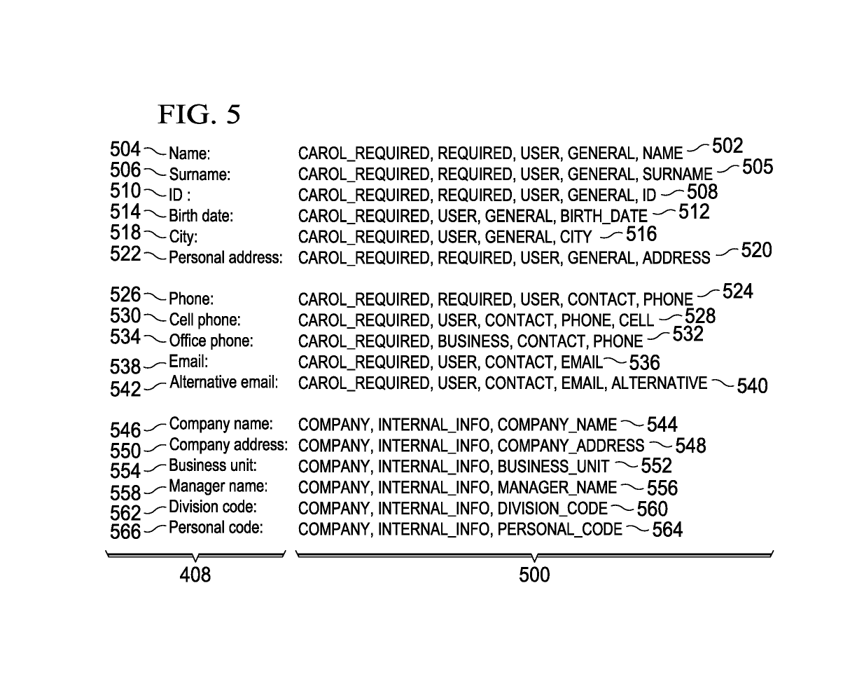

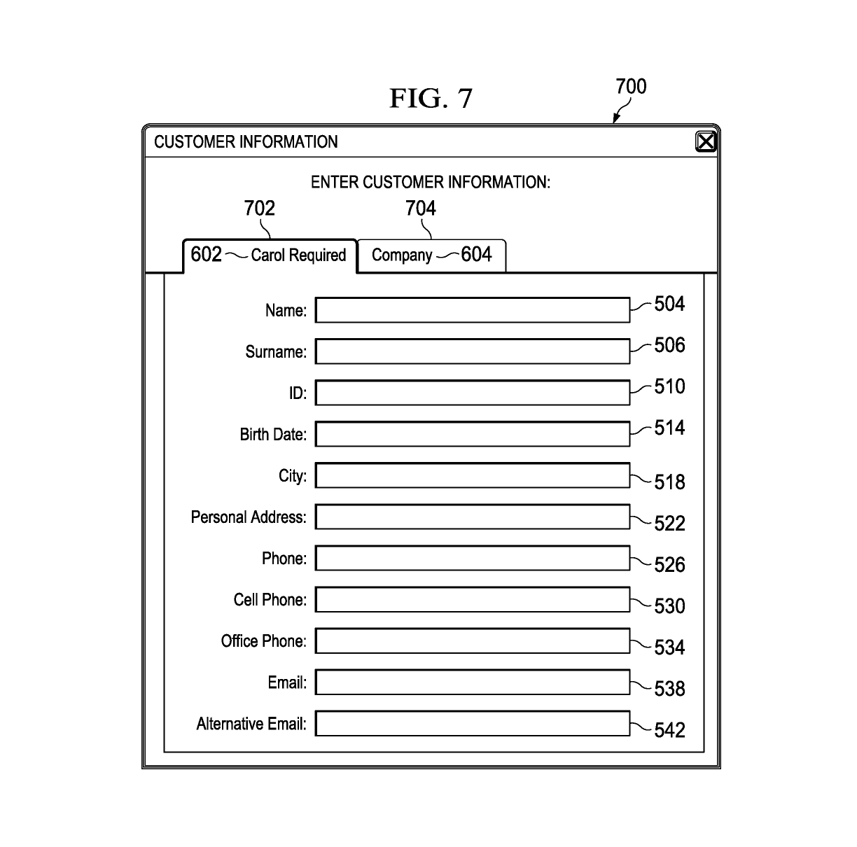

FIGS. 4-7 illustrate generating a user interface in accordance with an illustrative embodiment. FIG. 4 is an illustration of a user interface in tabular form as designed by a designer. FIG. 5 is an illustration of the tags associated with each field in the user interface identified while generating the user interface. FIG. 6 is an illustration of the user interface in tabular form as generated by a user interface management process. FIG. 7 is an illustration of the user interface in graphical form as generated by the user interface management process.

With reference now to FIG. 4, an illustration of a user interface presented in tabular form is depicted in accordance with an illustrative embodiment. User interface 400 is depicted as a table of fields. However, such a depiction is for illustrative purposes and is intended to depict the layout of a user interface as designed by a designer. User interface 400 is a tabular representation of an example implementation of user interface 310 in FIG. 3.

User interface 400 is depicted as user interface 400 is designed by a human designer in this illustrative embodiment. For example, user interface 400 may be a user interface that displays and/or requests customer information. Fields 408 represent an example implementation of group of fields 316 in FIG. 3. Title 402, title 404, and title 406 each represent the title of a tab on which the designer configures fields 408 to be displayed. More specifically, title 402 may be displayed on tab 338 in FIG. 3. In another illustrative example, title 404 may be displayed on tab 338 in FIG. 3, and in another illustrative example, title 406 may be displayed on tab 338 in FIG. 3.

In this illustrative example, a designer configures fields 410 to be displayed on a tab with title 402 Likewise, the designer configures fields 412 to be displayed on a tab with title 404. The designer further configures fields 414 to be displayed on a tab with title 406.

Looking now to FIG. 5, an illustration of the tags associated with each field in the user interface is depicted in accordance with an illustrative embodiment. Tags 500 are example implementations of tag 328 in FIG. 3.

In this illustrative example, tags 500 are associated with fields 408. More specifically, number of tags 502 is associated with field 504. Number of tags 502 may be identified by a user interface management process, such as user interface management process 314 in FIG. 3. The tags “Carol_Required,” “Required,” “User,” “General,” and “Name” are associated with field 504 in this illustrative embodiment. The tags may be identified as associated with different policies. For example, “Carol_Required” may be associated with a user policy, such as user policy 334 in FIG. 3. “Required” may be associated with a policy of an enterprise, such as enterprise 332 in FIG. 3. Other tags may be associated with a policy generated by the designer of the user interface. In this illustrative embodiment, the tags for each field are ordered by priority, from highest priority on the left, to lowest priority on the right. For example, “Carol_Required” is the highest priority tag for field 504 based on a number of policies, such as number of policies 322 in FIG. 3, and “Name” is the lowest priority tag for field 504.

Likewise, number of tags 505 is associated with field 506, number of tags 508 is associated with field 510, number of tags 512 is associated with field 514, number of tags 516 is associated with field 518, and number of tags 520 is associated with field 522. Number of tags 524 is associated with field 526, number of tags 528 is associated with field 530, number of tags 532 is associated with field 534, number of tags 536 is associated with field 538, and number of tags 540 is associated with field 542. Number of tags 544 is associated with field 546, number of tags 548 is associated with field 550, number of tags 552 is associated with field 554, number of tags 556 is associated with field 558, number of tags 560 is associated with field 562, and number of tags 564 is associated with field 566.

With reference now to FIG. 6, an illustration of a user interface in tabular form is depicted in accordance with an illustrative embodiment. User interface 600 is depicted in tabular form. Of course, such a depiction is merely illustrative and such information may be stored in a database, a linked list, or another suitable data structure.

In this illustrative example, a user interface management process, such as user interface management process 314 in FIG. 3, has generated the layout of user interface 600. Fields 506, 510, 514, 518, 522, 526, 530, 534, 538, and 542 are located in the tab with title 602, “Carol Required,” because the highest priority tag for each of fields 506, 510, 514, 518, 522, 526, 530, 534, 538, and 542 is “Carol Required.” Likewise, fields 546, 550, 554, 558, 562, and 566 are located on a tab with title 604, “Company,” because such tabs have a highest priority tag of “Company.”

Looking now to FIG. 7, an illustration of a user interface in graphical form is depicted in accordance with an illustrative embodiment. User interface 700 is a graphical representation of user interface 600 in FIG. 6.

User interface 700 is an example of one user interface that may be generated by user interface management process 314 in FIG. 3. In this illustrative example, fields 504, 506, 510, 514, 518, 522, 526, 530, 534, 538, and 542 are displayed as fields in which a user may view and/or enter data. Fields 504, 506, 510, 514, 518, 522, 526, 530, 534, 538, and 542 are presented on tab 702, which is the selected tab in user interface 700. The selected tab is the tab that is selected for display. In other words, the data associated with tab 702 is displayed and the data for tab 704 is hidden. Tab 702 has title 602, and tab 704 has title 604 in this illustrative embodiment. The user may activate tab 704 to hide the data associated with tab 702 and display the data associated with tab 704. For example, activating tab 704 would hide fields 504, 506, 510, 514, 518, 522, 526, 530, 534, 538, and 542 and display fields 546, 550, 554, 558, 562, and 566.

With reference now to FIG. 8, an illustration of a flowchart of a process for managing a user interface is depicted in accordance with an illustrative embodiment. The process may be performed by user interface management process 314 running on computer system 302 in FIG. 3.

The process begins by receiving a request to display a user interface (step 802). The process then identifies a number of tags associated with a group of fields for display in the user interface (step 804). The number of tags are an example implementation of number of tags 318 in FIG. 3. The group of fields is an example implementation of group of fields 316 in FIG. 3. The number of tags may be associated with a group of fields in a data source, such as database, or in metadata for the fields, or another suitable data structure.

The process then identifies a number of policies for displaying fields in the user interface (step 806). The number of policies may include a priority for a tag in the number of tags. The policy may also have a priority as compared to other policies in the number of policies. The process then displays the fields according to the priority for the tag in the number of tags identified in the number of policies (step 808). The process may display the fields by sending instructions to the computer system that sent the request to the process. The process may also display the fields by generating a number of images for the user interface and sending the images to the computer system that sent the request for display. The process terminates thereafter.

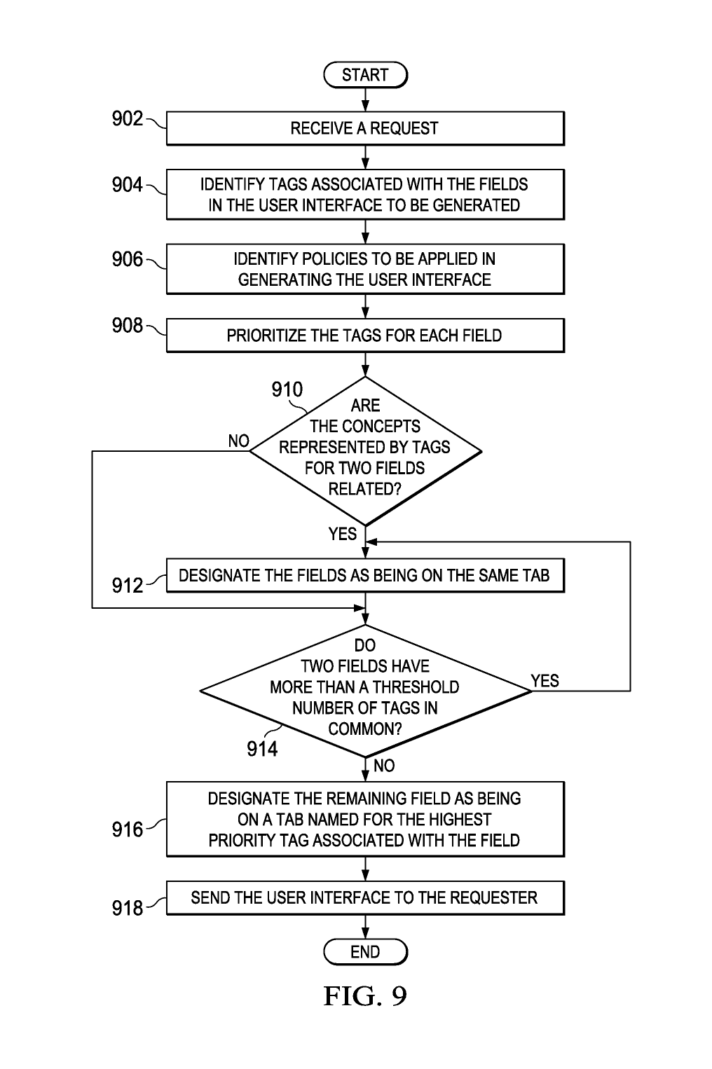

Turning now to FIG. 9, an illustration of a flowchart of a process for generating a user interface is depicted in accordance with an illustrative embodiment. The process may be performed by user interface management process 314 running on computer system 302 in FIG. 3.

The process begins by receiving a request (step 902). The process then identifies tags associated with the fields in the user interface to be generated (step 904). Next, the process identifies policies to be applied in generating the user interface (step 906). Thereafter, the process prioritizes the tags for each field (step 908).

The process then determines whether the concepts represented by tags for two fields are related (step 910). If the concepts represented by tags for two fields are related, the process designates the fields as being on the same tab (step 912). The process then determines whether two fields have more than a threshold number of tags in common (step 914). If two fields do not have more than the threshold number of tags in common, the process designates the remaining field as being on a tab named for the highest priority tag associated with the field (step 916). The process then sends the user interface to the requester (step 918), with the process terminating thereafter.

With reference again to step 914, if the two fields have more than the threshold number of tags in common, the process proceeds to step 912 as described above. Of course, in some illustrative embodiments, the process may not perform step 914 in the event that step 914 has already been performed and the process is proceeding from step 912 to step 914. Further, with reference again to step 910, if the concepts represented by tags for two fields are not related, the process proceeds directly to step 914 as described above.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing a user interface, the method comprising:
responsive to receiving a request to display the user interface, identifying a number of tags associated with a group of fields for display in the user interface;
identifying a number of policies for displaying fields in the user interface comprising a priority for a tag in the number of tags; and
displaying the fields according to the priority for the tag in the number of tags identified in the number of policies.

2. The method of claim 1, further comprising:
prior to receiving the request to display the user interface, receiving the number of tags and the fields with which the number of tags is to be associated; and
associating the number of tags with the fields to be displayed in the user interface.

3. The method of claim 2, wherein the number of tags comprises user-defined tags.

4. The method of claim 1, wherein identifying the number of policies for displaying the fields in the user interface comprising the priority for the tag in the number of tags comprises:
identifying a first policy associated with an enterprise; and
identifying a second policy associated with a user in the enterprise, wherein the first policy has a higher priority than the second policy.

5. The method of claim 1, wherein displaying the fields according to the priority for the tag in the number of tags identified in the number of policies comprises:
displaying the fields on a tab associated with the tag in the number of tags having a highest priority for the fields.

6. The method of claim 1, wherein displaying the fields according to the priority for the tag in the number of tags identified in the number of policies comprises:
determining whether a first field and a second field have at least a threshold number of tags in common; and
responsive to a determination that the first field and the second field have at least the threshold number of tags in common, displaying the first field and the second field on a same tab in the user interface.

7. The method of claim 6, wherein displaying the first field and the second field on the same tab in the user interface further comprises:
displaying the second field within a predetermined distance of the first field.

8. The method of claim 1, wherein the tag is a first tag that represents a first concept, and wherein displaying the fields according to the priority for the first tag in the number of tags identified in the number of policies comprises:
determining whether a second tag represents a second concept that is related to the first concept in a data source; and
responsive to a determination that the second tag represents the second concept that is related to the first concept in the data source, displaying a first field with which the first tag is associated on a same tab in the user interface as a second field with which the second tag is associated.

9. The method of claim 1, wherein the number of policies comprises a first user policy, wherein the number of tags comprises an identifier marking the fields as required by the first user and further comprising:
displaying the fields having the identifier in the number of tags associated with the fields on a same tab in the user interface.

10. A computer program product comprising:
a computer recordable storage medium;
program instructions, stored on the computer recordable storage medium, for identifying a number of tags associated with a group of fields for display in a user interface responsive to receiving a request to display the user interface;
program instructions, stored on the computer recordable storage medium, for identifying a number of policies for displaying fields in the user interface comprising a priority for a tag in the number of tags; and
program instructions, stored on the computer recordable storage medium, for displaying the fields according to the priority for the tag in the number of tags identified in the number of policies.

11. The computer program product of claim 10, further comprising:
program instructions, stored on the computer recordable storage medium, for, prior to receiving the request to display the user interface, receiving the number of tags and the fields with which the number of tags is to be associated; and
program instructions, stored on the computer recordable storage medium, for associating the number of tags with the fields to be displayed in the user interface.

12. The computer program product of claim 10, wherein the program instructions, stored on the computer recordable storage medium, for identifying the number of policies for displaying the user interface comprising the priority for the tag in the number of tags comprises:
program instructions, stored on the computer recordable storage medium, for identifying a first policy associated with an enterprise; and
program instructions, stored on the computer recordable storage medium, for identifying a second policy associated with a user in the enterprise, wherein the first policy has a higher priority than the second policy.

13. The computer program product of claim 10, wherein the program instructions, stored on the computer recordable storage medium, for displaying the fields according to the priority for the tag in the number of tags identified in the number of policies comprises:
program instructions, stored on the computer recordable storage medium, for displaying the fields on a tab associated with the tag in the number of tags having a highest priority for the fields.

14. The computer program product of claim 10, wherein the program instructions, stored on the computer recordable storage medium, for displaying the fields according to the priority for the tag in the number of tags identified in the number of policies comprises:
program instructions, stored on the computer recordable storage medium, for determining whether a first field and a second field have at least a threshold number of tags in common; and
program instructions, stored on the computer recordable storage medium, for displaying the first field and the second field on a same tab in the user interface responsive to a determination that the first field and the second field have at least the threshold number of tags in common.

15. The computer program product of claim 14, wherein the program instructions, stored on the computer recordable storage medium, for displaying the first field and the second field on the same tab in the user interface further comprises:
program instructions, stored on the computer recordable storage medium, for displaying the second field within a predetermined distance of the first field.

16. The computer program product of claim 10, wherein the tag is a first tag that represents a first concept, and wherein the program instructions, stored on the computer recordable storage medium, for displaying the fields according to the priority for the first tag in the number of tags identified in the number of policies comprises:
program instructions, stored on the computer recordable storage medium, for determining whether a second tag represents a second concept that is related to the first concept in a data source; and
program instructions, stored on the computer recordable storage medium, for displaying a first field with which the first tag is associated on a same tab in the user interface as a second field with which the second tag is associated responsive to a determination that the second tag represents the second concept that is related to the first concept in the data source.

17. The computer program product of claim 10, wherein the number of policies comprises a first user policy, wherein the number of tags comprises an identifier marking the fields as required by the user and further comprising:
program instructions, stored on the computer recordable storage medium, for displaying the fields having the identifier in the number of tags associated with the fields on a same tab in the user interface.

18. An apparatus comprising:
a bus system;
a storage device connected to the bus system, wherein the storage device includes program code; and
a processor unit connected to the bus system, wherein the processor unit processes the program code to identify a number of tags associated with a group of fields for display in a user interface responsive to receiving a request to display the user interface;
identifies a number of policies for displaying fields in the user interface comprising a priority for a tag in the number of tags; and displays the fields according to the priority for the tag in the number of tags identified in the number of policies.

19. The apparatus of claim 18, wherein the processor unit further processes the program code to, prior to receiving the request to display the user interface, receive the number of tags and the fields with which the number of tags is to be associated; and associate the number of tags with the fields to be displayed in the user interface.

20. The apparatus of claim 18, wherein the processor unit processing the program code to identify the number of policies for displaying the user interface comprising the priority for the tag in the number of tags comprises the processor unit processing the program code to identify a first policy associated with an enterprise; and identify a second policy associated with a user in the enterprise, wherein the first policy has a higher priority than the second policy.
